(19) United States
(12) Patent Application Publication
(10) Pub. No.: US 2010/0195193 A1
(43) Pub. Date: Aug. 5, 2010

(54) OPTICAL PULSE SOURCE DEVICE

(75) Inventors: Kenji Taira, Tokyo (JP); Hiroyoshi Yajima, Kanagawa (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/678,391

(22) PCT Filed: Mar. 24, 2009
(86) PCT No.: PCT/JP2009/055828

§ 371 Date: Mar. 16, 2010

(30) Foreign Application Priority Data
Mar. 24, 2008 (JP) 2008-076197

(51) Int. Cl. H01S 3/13

(52) U.S. Cl. 359/337.2

(57) ABSTRACT

An optical pulse source device comprising an optical pulse source (10) emitting an optical pulse train, optical amplifying means (20, 40) amplifying the optical pulse train and a saturable absorber device (30) removing noise floor in the optical pulse train. There is provided an optical pulse source device for multiphoton imaging system being of small size and high stability and capable of improving the SNR by its relatively simple configuration without using a synchronous circuit or an active time gate.

### CROSS REFERENCE TO RELATED APPLICATION

This application claims priority to and the benefit of Japan Patent Application No. 2008-76197 filed on Mar. 24, 2008, the entire content of which is incorporated herein by reference.

### TECHNICAL FIELD

This invention relates to an optical pulse source device used in a multiphoton imaging system observing an object through a multiphoton excitation process.

### BACKGROUND ART

It is expected that an ultrashort optical pulse source is applied in a broad range of fields including biology, medical care and hyperfine processing. Particularly in applications to biology and medical care, there is presently commercialized as the ultrashort optical pulse source a light source with a solid laser represented by a Titanium-sapphire laser. Such a light source with a solid laser is mainly used for research as a light source for nonlinear microscope imaging including a multiphoton-excited fluorescence microscope.

However, the solid laser represented by a Titanium-sapphire laser has problems that the device is large; the stability of laser output is low; its optical system is required to be adjusted each time and thus the operability is low; the device is expensive, and the like. Thus, the light source with a solid laser is used exclusively in a laboratory where air conditioning and a large vibration isolator are equipped and a professional laser operator is resident, and has not been in practical use in hospitals or biology laboratories in normal environments.

As the practical ultrashort optical pulse source for multiphoton imaging system, there has been developed a light source using a semiconductor laser. For example, Non-Patent Document 1 discloses an ultrashort optical pulse source for multiphoton imaging comprising a vertical cavity surface emitting laser (VCSEL) to be gain-switched, a single-mode optical fiber compensating a red-shift chirp of an optical pulse, an optical filter shaping a waveform, a semiconductor optical amplifier and an optical fiber amplifier.

This optical pulse source for multiphoton imaging is constituted, unlike a conventional light source such as one with a solid laser, by a semiconductor laser not requiring an external resonator, thereby high stability and excellent operability can be obtained and the device can be of small size. Furthermore, stabilization mechanism required for a conventional light source such as one with a solid laser, and the like are unnecessary, and the device can be constituted by relatively low-cost components, which reduces the price. That is, many of requisitions for a practical light source are fulfilled.

Non-patent Document 1: K. Taira et al., Optics Express, vol. 15, pp. 2454-2458 (2007)

### DISCLOSURE OF THE INVENTION

### Problems to be Solved by the Invention

FIG. 8(a) is a diagram illustrating a schematic configuration of an optical pulse source using a VCSEL and pulse waveforms on an optical path. In FIG. 8(a), the VCSEL 100 is gain-switched by an electrical pulse from an electrical pulse generator 101. The photon lifetime of the VCSEL 100 is shorter than that of an edge emitting semiconductor laser, which makes it possible to relatively easily obtain an ultrashort pulse having a pulse width of picosecond order. However, the optical power obtained from the VCSEL 100 is about one-order smaller than that of a gain-switched edge emitting semiconductor laser. Therefore, the optical pulse emitted from the gain-switched the VCSEL 100 is amplified by a semiconductor optical amplifier (SOA) 102. The SOA 102 is direct-current driven constantly by an amplifier control device 103. Here, the optical input power of the SOA 102 is small. Thus, when the input light having a small optical power is amplified by the SOA 102, the signal-to-noise ratio (SNR) of an output light is significantly deteriorated.

When the SNR of an optical pulse train from the SOA 102 is deteriorated, a noise floor appears between optical pulses on a time axis, as shown in FIG. 8(a). The instantaneous optical intensity of the noise floor is significantly smaller than a peak power of the optical pulse and thus is hardly contributes to a multiphoton excitation process in samples for a multiphoton imaging. However, the samples are continuously irradiated by the noise floor which exists between the optical pulses, which causes unnecessary heat in the samples and can thermally damage them. Therefore, it is a very important, with respect to the optical pulse source for the multiphoton imaging, to improve the SNR of the optical pulse with a noise floor reduction. The improvement of the SNR is particularly important for a light source employing an optical pulse source and an optical amplifier in a multiphoton imaging system.

Thus, in the above Non-Patent Document 1, the VCSEL 100 is gain-switched and an active time gate is applied to the optical pulses, as shown in FIG. 8(b), so that the noise floor between optical pulses is removed to improve the SNR of the optical pulse source.

That is, in this optical pulse source device, the amplifier control device 103 drives the SOA 102 through an ON/OFF operation in synchronization with a pulse drive of the VCSEL 100 by the electrical pulse generator 101, which causes the SOA 102 to act as an amplifier and a time gate so as to remove the noise floor between the optical pulses and thus improve the SNR.

It is necessary that the active time gate is constantly synchronized with an optical pulse output from the VCSEL 100. According to studies by the inventors, however, it is found that imperfect synchronization easily occurs between an optical pulse and a time gate due to heat from electric circuits and the like. Thus, it is required to provide equipment for stabilizing a temperature in an optical pulse source device and a feedback circuit for fixing synchronization, which complicates the configuration of the device and can result in a higher cost of the whole device.

Therefore, an object of the invention made focusing on these points is to provide an optical pulse source device for multiphoton imaging system being of small size and high stability and capable of improving the SNR by its relatively simple configuration without using an active time gate.

### SUMMARY OF THE INVENTION

A first aspect of the invention relating to an optical pulse source device for achieving the above object is an optical pulse source device used in a multiphoton imaging system observing an object though a multiphoton excitation process, comprising
an optical pulse source emitting an optical pulse train;
an optical amplifying means amplifying the optical pulse train; and
a saturable absorber device removing noise floor in the optical pulse train.

A second aspect of the invention is an optical pulse source device according to the first aspect, wherein the optical amplifying means comprises a plurality of optical amplifiers; and
the saturable absorber device is disposed between the sequential optical amplifiers.

A third aspect of the invention is an optical pulse source device according to the first aspect, wherein the saturable absorber device is disposed after the optical amplifying means.

A fourth aspect of the invention is an optical pulse source device according to the first aspect, wherein the saturable absorber device is disposed before the optical amplifying means.

A fifth aspect of the invention is an optical pulse source device according to the first aspect, wherein a pulse compressing means shortening a temporal width of an optical pulse is disposed before the saturable absorber device.

A sixth aspect of the invention is an optical pulse source device according to any one of the first to fifth aspects, wherein the saturable absorber device is constituted by a semiconductor saturable absorber device, a carbon nano-tube or a nonlinear optical loop mirror.

### Effect of the Invention

According to the invention, a saturable absorber device removes noise floor included in an optical pulse train emitted from a light pulse source, enabling an optical pulse source device used in a multiphoton imaging system improving the SNR by its relatively simple configuration.

### BRIEF DESCRIPTION OF DRAWINGS

FIG. 1 is a block diagram illustrating a schematic configuration of an optical system including an optical pulse source device for multiphoton imaging according to a first embodiment of the invention;

FIG. 2 is a diagram illustrating an example of incident light density-to-absorptance properties of a saturable absorber device;

FIG. 3 is a diagram illustrating a detail configuration of the multiphoton imaging system shown in FIG. 1;

FIG. 4 is a block diagram illustrating a schematic configuration of a multiphoton imaging system having an optical pulse source device for multiphoton imaging system according to a second embodiment of the invention;

FIG. 5 is a diagram illustrating a detail configuration of the multiphoton imaging system shown in FIG. 4;

FIG. 6 is a block diagram illustrating a schematic configuration of a multiphoton imaging system having an optical pulse source device for multiphoton imaging system according to a third embodiment of the invention;

FIG. 7 is a diagram illustrating a detail configuration of the multiphoton imaging system shown in FIG. 6; and

FIG. 8 is a diagram illustrating an optical pulse source device according to a conventional technique and pulse waveforms output thereby.

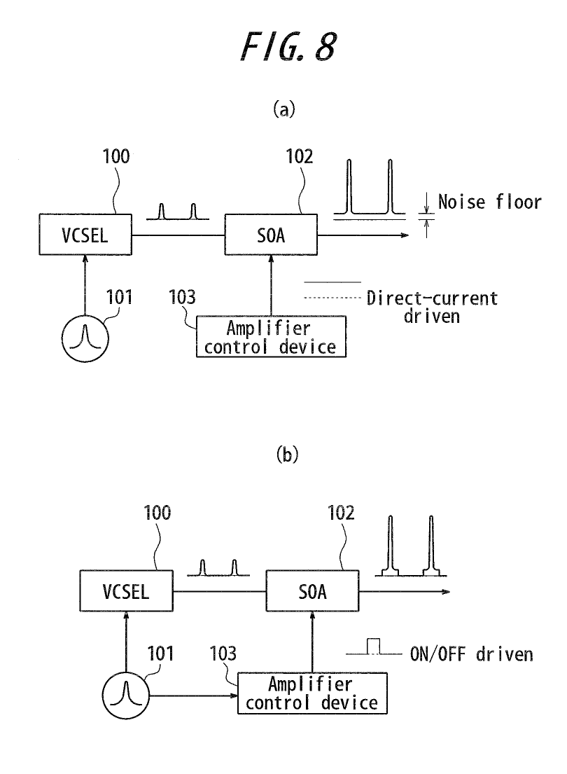

### REFERENCE SYMBOLS

10 optical pulse source

11 vertical cavity surface emitting laser (VCSEL)

12 electrical pulse generator

13 single-mode fiber (SMF)

20 first optical amplifier

21 Yb-doped fiber amplifier (YDFA)

22 band-pass filter (BPF)

30 saturable absorber device

31 resonant semiconductor saturable absorber mirror

32 carbon nano-tube (CNT)

40 second optical amplifier

41 Yb-doped fiber amplifier (YDFA)

42 high-power Yb-doped fiber amplifier (YDFA)

50 multiphoton imaging system

51 multiphoton-excited fluorescence microscope

52 collimator lens

53 XY galvano scanner mirror (XY-GM)

54 pupil lens (PL)

55 tube lens (TL)

56 dichroic mirror (DM)

57 photo-multiplier tube (PMT)

58 objective lens

59 sample

61 single-mode fiber (SMF)

62 collimator lens

63 total reflection mirror

64 total reflection mirror

70 pulse compressor

71 negative group-velocity dispersion compensator

72a diffraction grating

72b diffraction grating

73 reflective mirror

### BEST MODE FOR CARRYING OUT THE INVENTION

Embodiments of the invention will be described below with reference to the accompanying drawings.

### First Embodiment

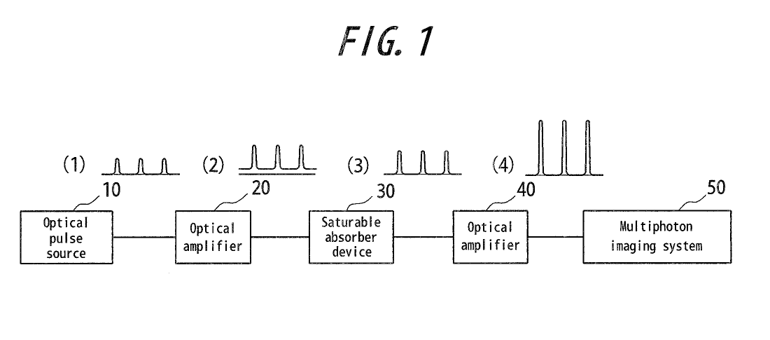

FIG. 1 is a block diagram illustrating a schematic configuration of a multiphoton imaging system having an optical pulse source device according to a first embodiment of the invention. In this figure, waveforms (1) to (4) of an optical pulse train transmitted between each component are also represented. The multiphoton imaging system according to the embodiment has an optical pulse source 10 constituting an optical pulse source device, a first optical amplifier 20, a saturable absorber device 30, a second optical amplifier 40 and a multiphoton imaging system 50. In the embodiment, the first optical amplifier 20 and the second optical amplifier 40 constitute an optical amplifying means. It is noted that the above components are connected to each other by a single-mode optical fiber.

In the above configuration, the optical pulse source 10 emits an optical pulse (1) having a repetition rate of 10 MHz and a pulse width of about 20 ps, for example, and renders the optical pulse (1) to be incident on the first optical amplifier 20. The first optical amplifier 20 acts as a pre-amplifier and amplifies the optical pulse (1) emitted from the optical pulse source 10. The amplified optical pulse (2) has noise floor caused by amplified spontaneous emission (ASE) noise and the like, which deteriorates the SNR.

Next, the optical pulse (2) amplified by the first optical amplifier 20 is incident on the saturable absorber device 30. The saturable absorber device 30 is constituted by a semiconductor saturable absorber mirror (SESAM), a carbon nano-tube (CNT), a nonlinear optical loop mirror (NOLM) or the like, for example.

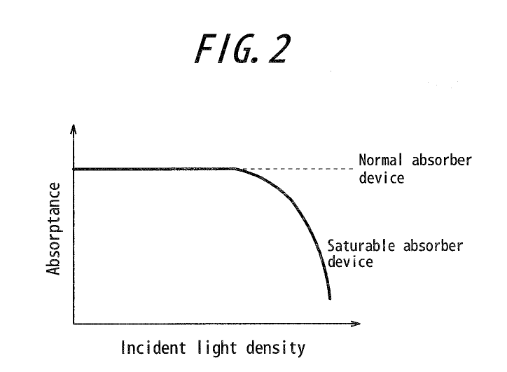

FIG. 2 is a diagram illustrating an example of incident light density-to-absorptance properties of the saturable absorber device 30. The optical absorptance by the saturable absorber device 30 is lowered when the intensity of incident light is high. That is, the optical transmittance and reflectance of the saturable absorber device 30 depend on the intensity of incident light. When the intensity of incident light is low, the transmittance or the reflectance is low, while when the intensity of incident light is high, the transmittance or the reflectance is high. Therefore, when an incident light into the saturable absorber device 30 is of an optical pulse train, the transmittance or the reflectance is the highest at a peak of the optical pulse and is low at a portion where an optical intensity is low between optical pulses. That is, the saturable absorber device 30 can remove noise floor existent between optical pulses and acts as a passive time gate for optical pulses. It is preferable that the saturable absorber device 30 has a high response speed for change of the intensity of incident light. In the embodiment, however, optical pulses are very sparsely disposed on the time axis and the recovery time, from a state where the absorptance is lowered due to passage of an optical pulse to a state where the absorptance is recovered to be high after the passage of the optical pulse, may be longer than the pulse width.

In FIG. 1, the incident optical pulse (2) passes through the saturable absorber device 30 having the above absorptance properties and then becomes an optical pulse (3) from which noise floor has been removed. The optical pulse (3) emitted from the saturable absorber device 30 is amplified by the second optical amplifier 40 which is a high-power amplifier as shown in an optical pulse (4), and introduced into a multiphoton imaging system 50 to be used for observing samples. Here, the noise floor has been removed from the optical pulse (3) incident on the amplifier 40, and thus the optical pulse (4) amplified by the optical amplifier 40 has the high SNR.

Thereby, the multiphoton imaging system 50 can prevent generation of unnecessary heat in samples so as not to thermally damage the samples. In the configuration, the saturable absorber device 30 is provided after the first optical amplifier 20 acting as a pre-amplifier, which suppresses the noise of the incident light at the subsequent second optical amplifier 40 which is a high-power amplifier. It is thus possible to suppress the electric power consumption amplifying the noise component and efficiently amplify the optical pulses.

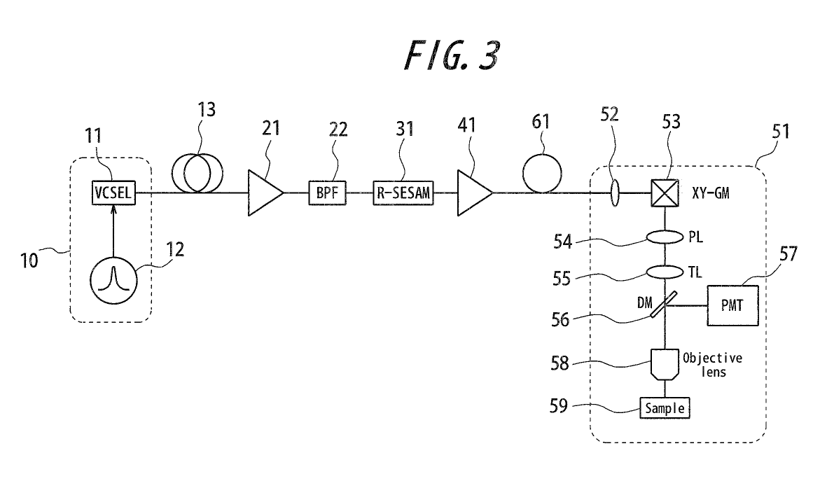

FIG. 3 is a diagram illustrating a detail configuration of the multiphoton imaging system shown in FIG. 1. This multiphoton imaging system uses, as the optical pulse source 10, a gain-switched vertical cavity surface emitting laser (GS-VCSEL) comprising a VCSEL 11 oscillating in a single longitudinal-mode/single-transverse-mode at a wave length of 978 nm and an electrical pulse generator 12 generating current pulses having a repetition rate of 10 MHz and a pulse width of about 800 ps so as to generate an optical pulse having a down-chirp with a pulse width of about 20 ps.

The emitted light from the VCSEL 11 is guided by a silica-based single-mode fiber (SMF) 13 compensating a down-chirp of the optical pulse and having a length of about 500 meters. The emitted light passes through the SMF 13, thereby the temporal width of the optical pulse is compressed down to about 3 ps.

The output optical pulse from the SMF 13 is amplified to have an optical average power of 2 mW by a Yb-doped fiber amplifier (YDFA) 21 constituting the first optical amplifier 20. Furthermore, a band-pass filter (BPF) 22 made of dielectric multilayer having a transmission bandwidth of about 0.60 nm removes ASE and pedestals from the optical pulse emitted from the YDFA 21.

Thereafter, the output optical pulse from the BPF 22 is incident on a resonant semiconductor saturable absorber mirror (R-SESAM) 31 in which reflective mirrors are disposed at both ends of the SESAM constituting the saturable absorber device 30, and the noise floor in the optical pulse train is removed as described in FIG. 2. Next, the output optical pulse from the R-SESAM 31 is incident on a high-power YDFA 41 constituting the second optical amplifier 40 and amplified to have an optical average power of 50 mW. Furthermore, the output optical pulse from the YDFA 2 is introduced into a laser-scanning multiphoton-excited fluorescence microscope 51 via a 2-meter-long SMF 61.

The multiphoton-excited fluorescence microscope 51 is constituted by a collimator lens 52, an XY galvano scanner mirror (XY-GM) 53, a pupil lens (PL) 54, a tube lens (TL) 55, a dichroic mirror (DM) 56, a photo-multiplier tube (PMT) 57, an objective lens 58 and a sample 59 to be observed.

The optical pulse incident on the multiphoton-excited fluorescence microscope 51 passes through the collimator lens 52 and is reflected by the XY-GM 53. Then, the optical pulse passes through the PL 54, the TL 55, the DM 56 and the objective lens 58 and irradiates the sample 59. Here, the XY-GM 53 allows an incident light to perform scanning so as to scan the irradiated position by the optical pulse on the sample. This irradiation by the optical pulse makes it possible that a fluorescence generated in the sample 59 through the multiphoton process passes through the objective lens 58, is split from the incident light by the DM 56 and amplified by the PMT 57 to be observed.

This configuration enables an optical pulse source device for multiphoton imaging system generating an optical pulse train having a center wavelength of 978 nm, a peak power of 1.5 kW, a pulse width of 3 ps and a repetition rate of 10 MHz. The optical pulse source device comprises a saturable absorber device, thereby the sufficiently high SNR can be obtained without providing an active time gate such as a synchronous circuit or the like. Therefore, it is possible to achieve a low-cost optical pulse source device for multiphoton imaging capable of stabilizing output with its small size and having a high operability. In this configuration, furthermore, the R-SESAM 31 is located after the YDFA 21 acts as a pre-amplifier, which removes the noise floor generated at the YDFA 21 and suppresses the noise of the incident light at the subsequent YDFA 41 which acts as a high-power amplifier, so that the optical pulse can be amplified efficiently.

### Second Embodiment

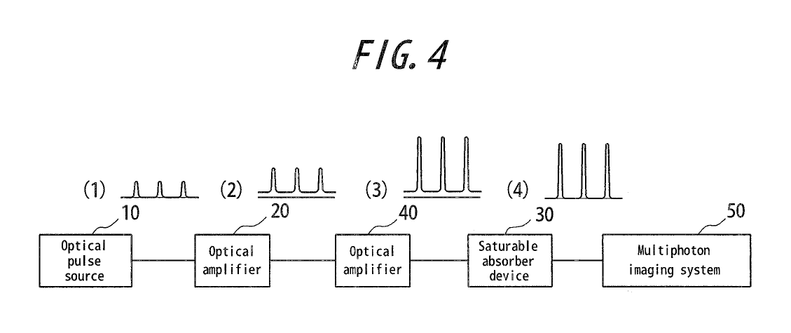

FIG. 4 is a block diagram illustrating a schematic configuration of a multiphoton imaging system having an optical pulse source device according to a second embodiment of the invention. Like FIG. 1, waveforms (1) to (4) of an optical pulse train transmitted between each component are also represented. In FIG. 4, the saturable absorber device 30 is provided not before but after the second optical amplifier 40 in the first embodiment shown in FIG. 1. That is, in this embodiment, the saturable absorber device 30 is provided after the second optical amplifying means 40.

In the multiphoton imaging system having this configuration, an optical pulse (1) emitted from the optical pulse source 10 is amplified by the first optical amplifier 20 as shown in an optical pulse (2). The amplified optical pulse (2) is further amplified by the second amplifier 40 without removing noise although its SNR is deteriorated due to ASE and the like. An optical pulse (3) output from the second amplifier is incident on the saturable absorber device 30 and becomes an optical pulse (4) from which noise has been removed to be introduced into the multiphoton imaging system 50.

Thereby, like the first embodiment, the multiphoton imaging system 50 can prevent samples from being thermally damaged by heat generated by the noise floor. Furthermore, the saturable absorber device 30 is provided after the optical amplifying means constituted by the first optical amplifier 20 and the second optical amplifier 40, and the output optical pulse from the saturable absorber device 30 is introduced into the multiphoton imaging system 50 without amplifying it. Thus, the SNR of the optical pulse incident on the multiphoton imaging system 50 can be higher as compared with the first embodiment.

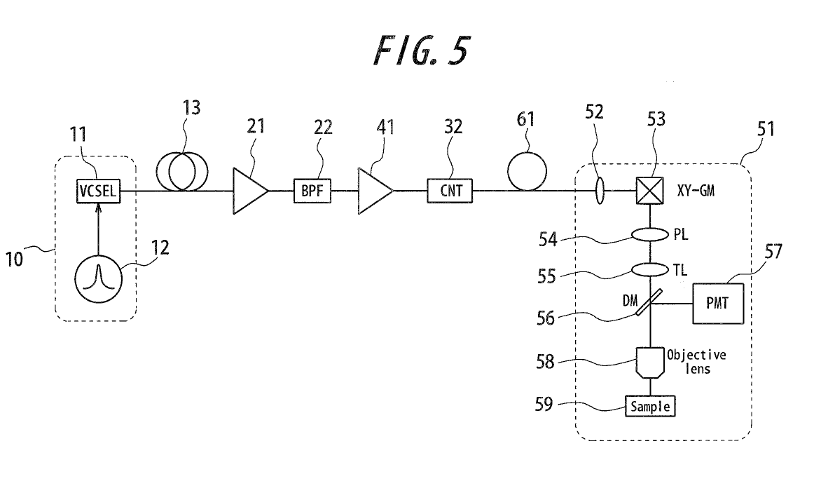

FIG. 5 is a diagram illustrating a detail configuration of the multiphoton imaging system shown in FIG. 4. In this multiphoton imaging system, the R-SESAM 31 is removed from the detail configuration of the first embodiment shown in FIG. 3, and the CNT 32 is provided therein after the YDFA 41 as the saturable absorber device.

The configuration shown in FIG. 5 makes it possible that the noise floor is removed from the optical pulse from the VCSEL 11 by the CNT 32 disposed after the YDFA 41. The optical pulse from which the noise floor has been removed is guided into the multiphoton-excited fluorescence microscope 51 via the SMF 61 without being further amplified, that is, without the entailing noise components generated by amplification. Therefore, the SNR of the optical pulse used in the multiphoton-excited fluorescence microscope 51 is further improved, and heat damages to samples by the optical noise can be further reduced.

### Third Embodiment

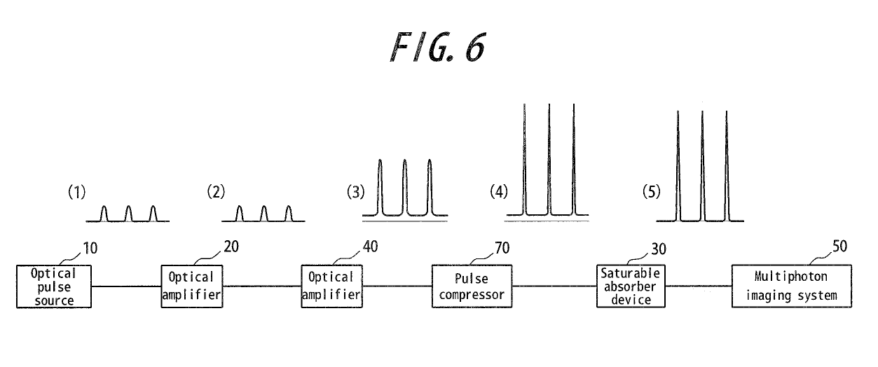

FIG. 6 is a block diagram illustrating a schematic configuration of a multiphoton imaging system having an optical pulse source device according to a third embodiment of the invention. Like FIG. 1 and FIG. 4, waveforms (1) to (5) of an optical pulse train transmitted between each component are also represented. In FIG. 6, a pulse compressor 70 is provided between the optical amplifier 40 and the saturable absorber device 30 in the second embodiment shown in FIG. 4. That is, in this embodiment, the saturable absorber device 30 is provided after the optical pulse compressing means.

In the multiphoton imaging system having this configuration, an optical pulse (1) emitted from the optical pulse source 10 is amplified by the first optical amplifier 20 as shown in an optical pulse (2), and is further amplified by the second optical amplifier 40 as shown in an optical pulse (3). With respect to the amplified optical pulse (3), the temporal width is compressed by the pulse compressor 70 without removing the noise although its SNR is deteriorated due to ASE and the like. An optical pulse (4) output from the pulse compressor 70 is incident on the saturable absorber device 30 and becomes an optical pulse (5) from which the noise has been removed to be introduced into the multiphoton imaging system 50.

Thereby, like the second embodiment, the multiphoton imaging system 50 can prevent samples from being thermally damaged by heat generated by the noise floor. Furthermore, the pulse compression increases the optical pulse peak power, hence the saturable absorber device 30 disposed after the pulse compressor can exert greater effects of saturable absorption. Thus, the SNR of the optical pulse incident on the multiphoton imaging system 50 can be higher as compared with the second embodiment.

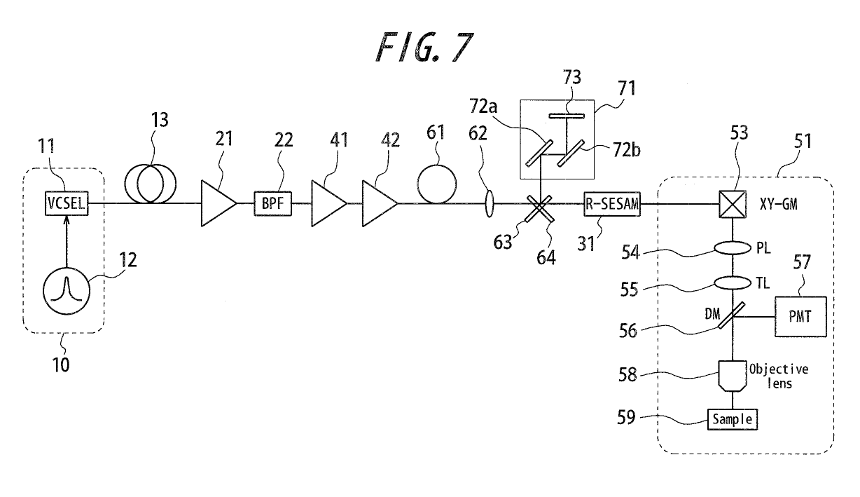

FIG. 7 is a diagram illustrating a detail configuration of the multiphoton imaging system shown in FIG. 6. In this multiphoton imaging system, the following modifications are added to the detail configuration of the second embodiment shown in FIG. 5. That is, the CNT 32 is removed, and a high-power YDFA 42 is disposed between the YDFA 41 and the SMF 61. Moreover, there are disposed, between the SMF 61 and a laser scanning microscope (LSM) 51, a collimator lens 62, a negative group-velocity dispersion compensator 71, the R-SESAM 31, a reflection mirror 63 causing an optical pulse emitted from the collimator lens to be incident on the negative group-velocity dispersion compensator 71 and a reflection mirror 64 causing the optical pulse emitted from the negative group-velocity dispersion compensator 71 to be incident on the R-SESAM 31.

The high-power YDFA 42 has a-few-W-level output and enables the optical pulse intense. The intense optical pulse causes the self-phase modulation (SPM) effect in the high-power YDFA 42 or the SMF 61. An interaction between this SPM effect and the group-velocity dispersion effect, which are occurred in optical fibers of the high-power YDFA 42 and in the SMF 61, broadens the optical spectral width as well as the temporal width, and also accumulates a chirp on the optical pulse.

The negative group-velocity dispersion compensator 71 is used, as the pulse compressor 70. The negative group-velocity dispersion compensator 71 consists of two reflective diffraction gratings 72a, 72b and a reflective mirror 73. The optical pulse incident on the first reflective diffraction grating 72a is diffracted, emitted at a different angle depending on each wavelength component, and rendered to be a parallel beam by the second reflective diffraction grating 72b. However, the spatial profile of the optical pulse is of elliptical shape, which has been changed from a circular shape at the time of incidence. The optical pulse is reflected by the reflective mirror 73 in parallel with the incident light at a different height position from the incident height position in a direction parallel with a groove of the reflective diffraction grating, and is diffracted again by the two diffraction gratings 72a and 72b to be of the original circular shape.

The negative group-velocity dispersion compensator 71 is a negative group-velocity dispersing means. The negative group-velocity dispersion compensates the chirp of the optical pulse described above. Since the width of the optical spectrum is enlarged, the a-few-picosecond optical pulse output from the SMF 61 is compressed down to a few hundreds femtosecond. In the experiments here, the optical pulse having a pulse width of 5 ps to 30 ps output from the SMF 61 is compressed down to be of 200 fs to 300 fs. It is noted that a transmission diffraction grating, a prism, a grism or the like, in addition to a reflective diffraction grating, can be used as the negative group-velocity dispersing means.

In FIG. 7, the R-SESAM 31 is disposed between the reflection mirror 64 and the multiphoton-excited fluorescence microscope 51. However, the R-SESAM 31 may be disposed inside the multiphoton-excited fluorescence microscope 51 or disposed so that the optical pulse from the negative group-velocity dispersion compensator 71 is incident directly thereon without using the reflection mirror 64. Moreover, the negative group-velocity dispersion compensator 71 may be disposed inside the multiphoton-excited fluorescence microscope 51.

According to the configuration shown in FIG. 7, the optical pulse emitted from the VCSEL 11 becomes a pulse whose temporal width has been compressed down to 200 fs to 300 fs by the negative group-velocity dispersion compensator 71 to have a very high peak-power, from which the R-SESAM 31 disposed after the negative group-velocity dispersion compensator 71 removes the noise floor. When the peak-power of the optical pulse is high, the effects of saturable absorption can be obtained more efficiently at the R-SESAM. Thus, the use of the configuration shown in FIG. 7 further improves the SNR of the optical pulse used in the multiphoton-excited fluorescence microscope 51, and further reduces heat damages to samples by the optical noise.

It is noted that the use of the saturable absorber device in an optical pulse source device for multiphoton imaging system is very suitable as an application of the saturable absorber device in the following respects.

That is, a high optical intensity is required to cause the saturable absorber device to perform saturable absorption. For example, the optical intensity of not less than 100 μJ/cm² is required to obtain a sufficient saturable absorption effect. In addition, the peak intensity/noise floor intensity of the incident optical pulse which is not less than about 10³ to 10⁴ is required to sufficiently exert the noise reduction function by the SESAM. The application meets such requirements is limited, which is the reason why the saturable absorber device has not been widely used.

On the other hand, the optical pulse source device for multiphoton imaging system uses an optical pulse having a repetition rate of 1 MHz to 100 MHz, a pulse width of 0.1 ps to 10 ps and a pulse energy of about 1 to 20 nJ. When the beam diameter of this optical pulse is narrowed to about 10 μm, the density of optical intensity becomes about some mJ/cm². Moreover, optical pulse width/pulse interval is about 10⁻⁵ to 10⁻⁶, and the optical pulse is very sparsely disposed on the time axis. Thus, when the SNR is 1, for example, namely when a time-averaged optical signal power is equal to noise power, peak intensity/noise floor intensity of the incident optical pulse is 10⁵ to 10⁶, which can sufficiently exert the noise reduction performance by the SESAM. For example, according to an experiment by the inventors, it is confirmed that the SNR of an optical pulse is improved by 170 times by disposing the SESAM on an optical path so that the optical pulse is reflected 10 times.

As the above, it is very effective to use the saturable absorber device in an optical pulse source device for a multiphoton imaging system.

It is noted that the invention is not limited to the above embodiments, and many variations and modifications can be implemented. For example, the saturable absorber device 30 may be disposed directly after the optical pulse source 10, that is, before the optical amplifying means. Moreover, the optical amplifying means can be constituted by one optical amplifier or by three or more optical amplifiers. Furthermore, the number of saturable absorber device is not limited to one, and it can be disposed in any positions such as before and after the amplifier, or the like.

In addition, the multiphoton imaging system is not limited to an imaging device by a multiphoton-excited fluorescence microscope, and may be a second-harmonic generation (SHG) imaging device, a third-harmonic generation (THG) imaging device or a coherent anti-Stokes Raman scattering (CARS) imaging device. Moreover, the invention is effective when used in a microscope using a multiphoton excitation process, and can be also applied to other imaging devices such as an endoscope and the like using a multiphoton excitation process.

1. An optical pulse source device used in a multiphoton imaging system observing an object though a multiphoton excitation process, comprising
an optical pulse source emitting an optical pulse train;
an optical amplifying means amplifying the optical pulse train; and
a saturable absorber device removing noise floor in the optical pulse train.

2. An optical pulse source device according to claim 1, wherein the optical amplifying means comprises a plurality of optical amplifiers; and
the saturable absorber device is disposed between the sequential optical amplifiers.

3. An optical pulse source device according to claim 1, wherein the saturable absorber device is disposed after the optical amplifying means.

4. An optical pulse source device according to claim 1, wherein the saturable absorber device is disposed before the optical amplifying means.

5. An optical pulse source device according to claim 1, wherein a pulse compressing means shortening a temporal width of an optical pulse is disposed before the saturable absorber device.

6. An optical pulse source device according to any one of claims 1 to 5, wherein the saturable absorber device is constituted by a semiconductor saturable absorber device, a carbon nano-tube or a nonlinear optical loop mirror.
